(19) United States
(12) Patent Application Publication
(10) Pub. No.: US 2010/0221953 A1
(43) Pub. Date: Sep. 2, 2010

(54) ELECTRICAL CONNECTOR HAVING CONTACT TERMINALS CONFIGURED BY INTEGRATING INDIVIDUALLY CONSTRUCTED TERMINAL UNIT

(75) Inventor: FENG PAN, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/713,180

(22) Filed: Feb. 26, 2010

(30) Foreign Application Priority Data
Feb. 27, 2009 (CN) 200920300935.6

(51) Int. Cl. H01R 24/00

(52) U.S. Cl. 439/626

(57) ABSTRACT

An electrical connector includes a shroud and a number of contact modules side-by-side assembled to the shroud. Each contact module includes an insulator and paired first and second contacts embedded in the insulator. The first and the second contacts respectively include first and second contact arms extending along a first direction. The first and the second contact arms respectively include first and second contacting sections under a condition that the first and the second contacting sections overlap along a second direction perpendicular to the first direction. The first and the second contacts are separate while come to mechanically touch each other when the first and the second contacts are embedded in the insulator.

### BACKGROUND OF THE INVENTION

1. Field of the Invention

The present invention relates to an electrical connector, and more particularly, to a backplane connector having contact terminals configured by integrating with individually constructed terminal unit and featured with a simplified and robust configuration benefiting cost-effective manufacturing process.

2. Description of Related Art

U.S. Pat. No. 6,899,548 issued to Houtz on May 31, 2005 discloses an electrical connector including an insulative housing and a plurality of membrane-type contacts attached to the insulative housing. Each contact includes a fixation portion, a pair of contact arms extending upwardly from the fixation portion and a tail portion extending downwardly from the fixation portion. The pair of arms are configured to offset from each other and include contacting sections for sandwiching a corresponding contact of a mating connector inserted therebetween. However, it is obvious that the fork-shaped arms are difficult for manufacture, especially in stamping process from an integral metal sheet because the fixation portion is thin and may be comparably very weak. Besides, there is a limit on creating the minimum gap between the pair of contact arms.

Hence, an improved electrical connector and a contact module thereof for being easily manufactured are needed to solve the above problems.

### BRIEF SUMMARY OF THE INVENTION

The present invention provides an electrical connector including a shroud and a plurality of contact modules side-by-side assembled to the shroud. Each contact module includes an insulator and paired first and second contacts embedded and stacked against each other in the insulator. The first and the second contacts respectively include first and second contact arms extending along a first direction. The first and the second contact arms respectively include first and second contacting sections under a condition that the first and the second contacting sections overlap with each other along a second direction perpendicular to the first direction. The first and the second contacts are separately made and then come to mechanically and electrically touch each other when the first and the second contacts are embedded in the insulator.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of an electrical connector in accordance with an embodiment of the present invention;

FIG. 2 is a part exploded view of the electrical connector with contact modules separated from a shroud;

FIG. 3 is an exploded view of the contact module;

FIG. 4 is a side view of the contact module as shown in FIG. 2;

FIG. 5 is a perspective view of the contacts of the contact module as shown in FIG. 2;

FIG. 6 is a top view of the contacts as shown in FIG. 5; and

FIG. 7 is a front view of the electrical connector as shown in FIG. 1.

### DETAILED DESCRIPTION OF THE PREFERRED EMBODIMENT

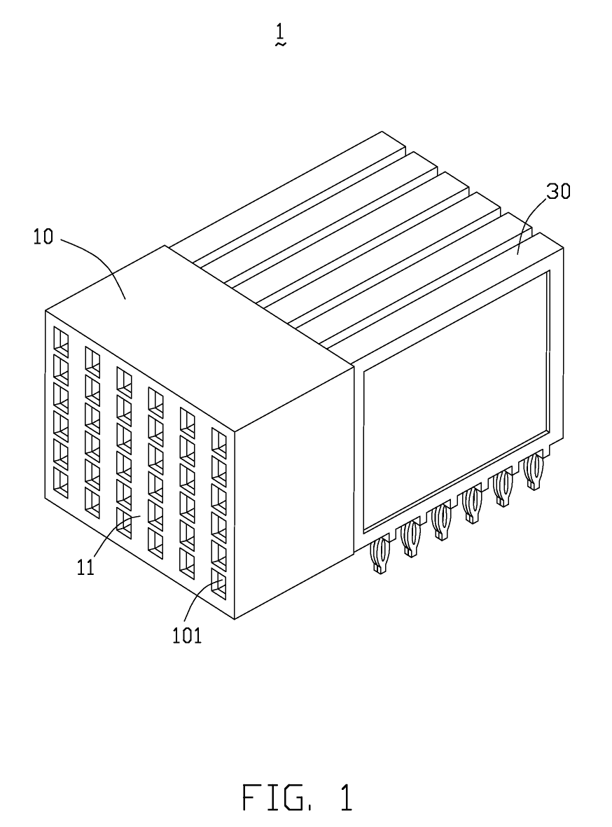

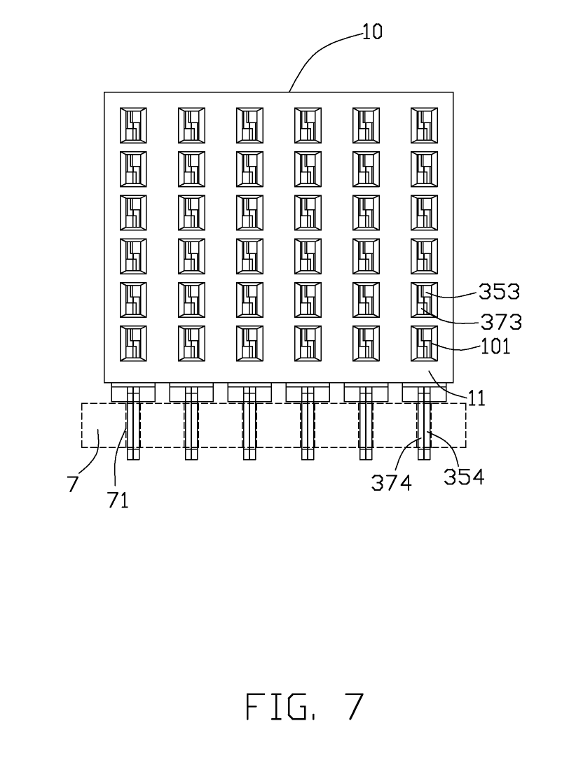

Reference will now be made to the drawing figures to describe the preferred embodiment of the present invention in detail. FIGS. 1 & 2 illustrate a high speed electrical connector 1 including a shroud 10 and a plurality of contact modules 30 side-by-side assembled to the shroud 10. The electrical connector 1 is mounted on a circuit board 7 (as best shown in FIG. 7) for mating with a header connector (not shown).

The shroud 10 includes a mating face 11, a mounting face 13 opposite to the mating face 11 and a plurality of receiving slots extending through the mating and the mounting faces 11, 13. The receiving slots include a plurality of holes 101 arranged in matrix and recessed from the mating face 11, and a plurality of slots 103 recessed from the mounting face 13. The slots 103 are in communication with the corresponding holes 101. The contact modules 30 are assembled to the receiving slots from the mounting face 13 to the mating face 11 along a rear-to-front direction.

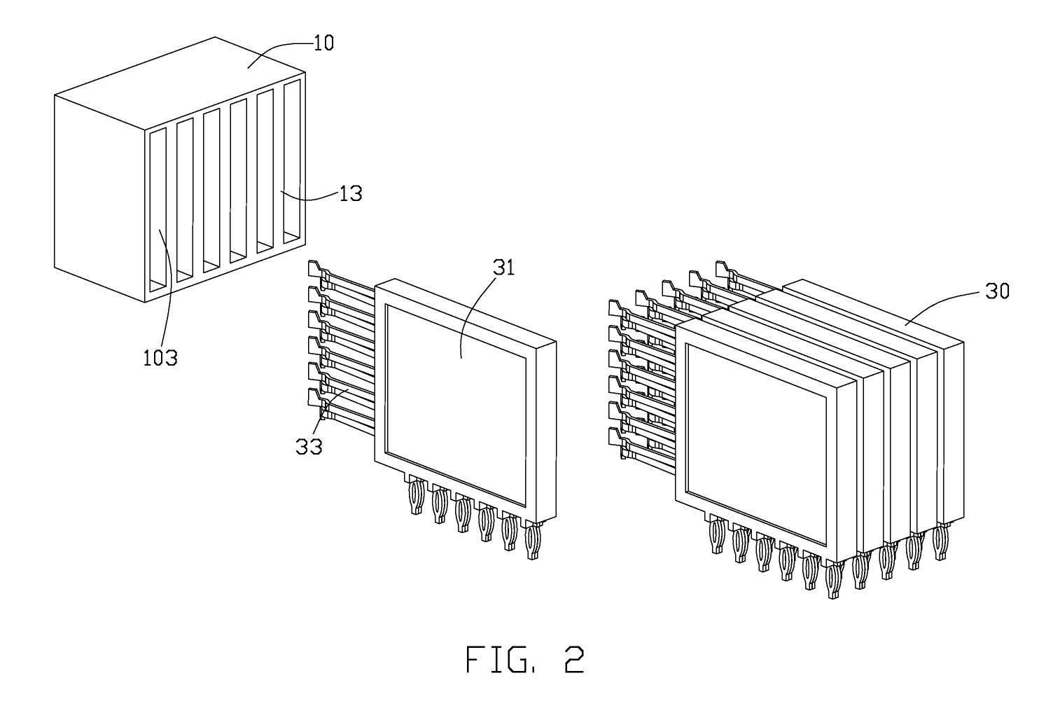

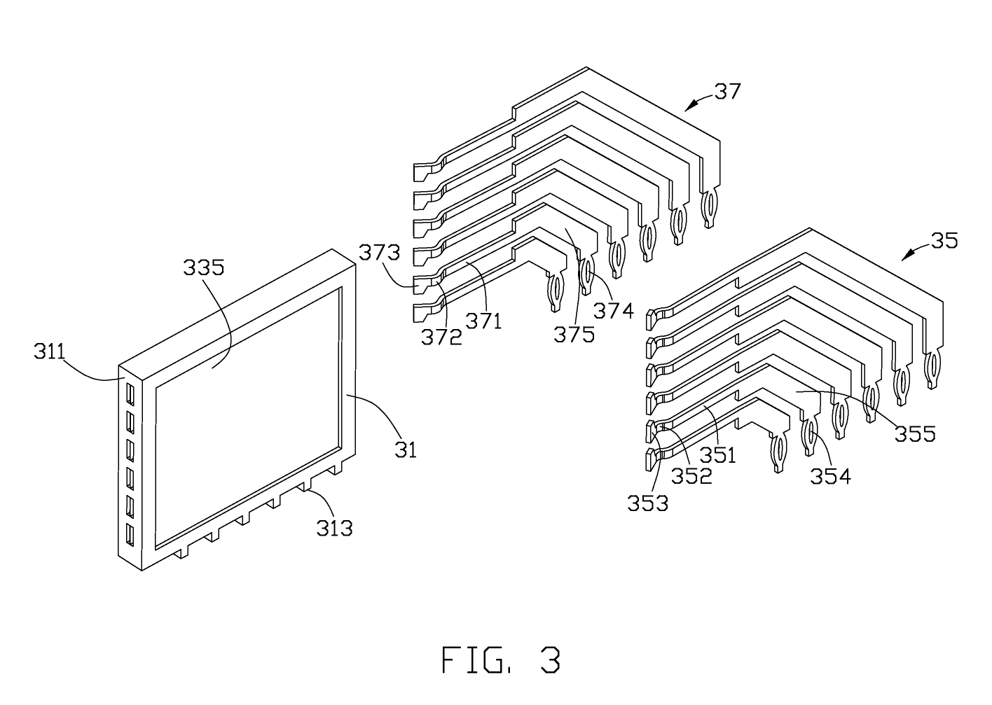

Referring to FIGS. 2 and 3, each contact module 30 includes an insulator 31 and a plurality of contacts 33 embedded in the insulator 31. The insulator 31 includes a front edge 311 perpendicular to the circuit board 7, a bottom edge 313 parallel to the circuit board 7 and a pair of opposite sides 335.

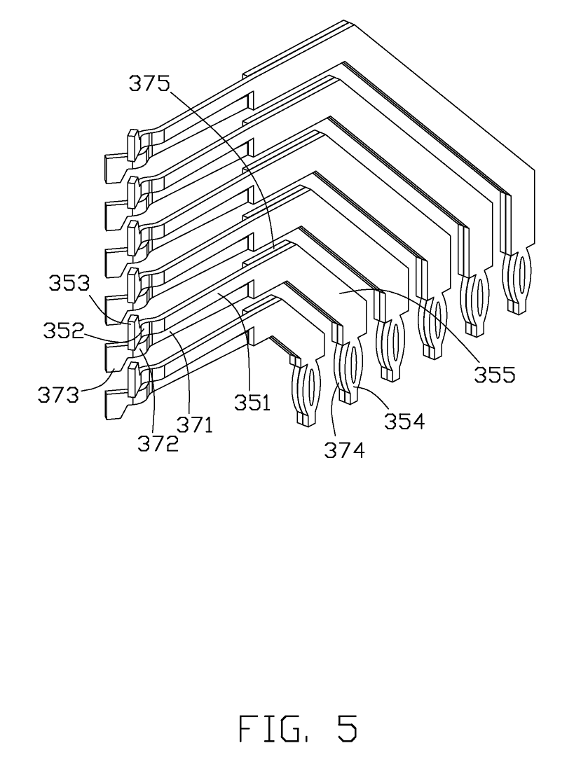

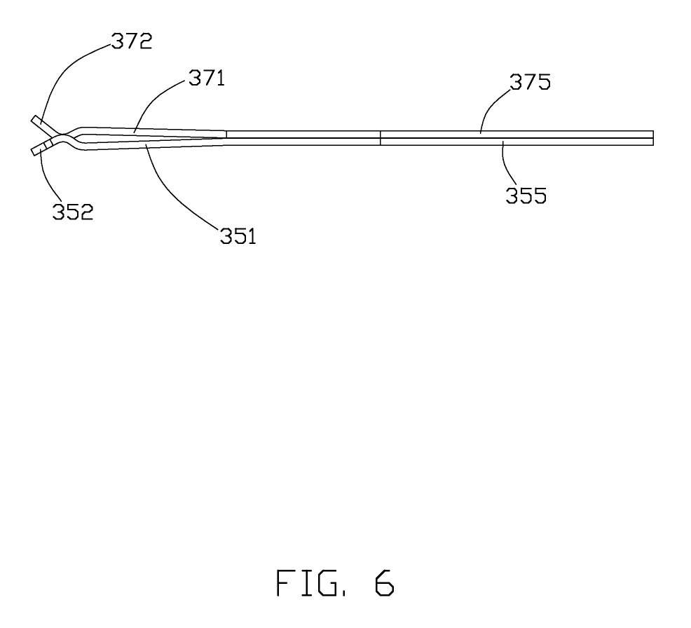

Referring to FIGS. 3 and 6, the contacts 33 include a plurality of first contacts 35 and a plurality of second contacts 37 paired with the first contacts 35. Since the first contacts 35 are of the same configuration, and only one of them will be detailedly described hereinafter for simplicity. Similarly, the second contacts 37 are also of the same configuration and only one of them will be detailedly described as well. The selected first contact 35 and the selected second contact 37 are coupled with each other for jointly mating with a same mating contact (not shown) of the header connector. The first and the second contacts 35, 37 are stacked against each other in the insulator 31. That is to say, the first and the second contacts 35, 37 mechanically and electrically touch each other as shown in FIGS. 5 and 6.

The first contact 35 includes a cantilevered first contact arm 351, a first tail end 354 and a first body 355 connecting the first contact arm 351 and the first tail end 354. The first contact arm 351 extends forwardly from a front and top edge of the first body 355. The first contact arm 351 includes a curved first contacting section 352 which further includes a distal end 353 bent outwardly from the first contacting section 352.

Similarly, the second contact 37 includes a cantilevered second contact arm 371, a second tail end 374 and a second body 375 connecting the second contact arm 371 and the second tail end 374. The second contact arm 371 extends forwardly from a front and bottom edge of the second body 375. The second contact arm 371 includes a curvilinear second contacting section 372 which further includes a distal end 373 bent outwardly from the second contacting section 372.

The first and the second contact arms 351, 371 are offset from each other along the front edge 311 of the insulator 31. The first and the second contacting sections 352, 372 are bent towards each other as a result that the first and the second contacting sections 352, 372 overlap along a vertical direction perpendicular to the rear-to-front direction. The first and the second bodies 355, 375 are aligned with each other along a third direction perpendicular to the rear-to-front direction and the vertical direction, and mechanically and electrically engage each other to establish connection thereof. The first and the second bodies 355, 375 are embedded in the insulator 31 for facilitating organizing the contacts 33. The first and the second tail ends 354, 374 are aligned with each other along the third direction and directly engage each other for being compressibly received in a same hole 71 of the circuit board 7 as shown in FIG. 7.

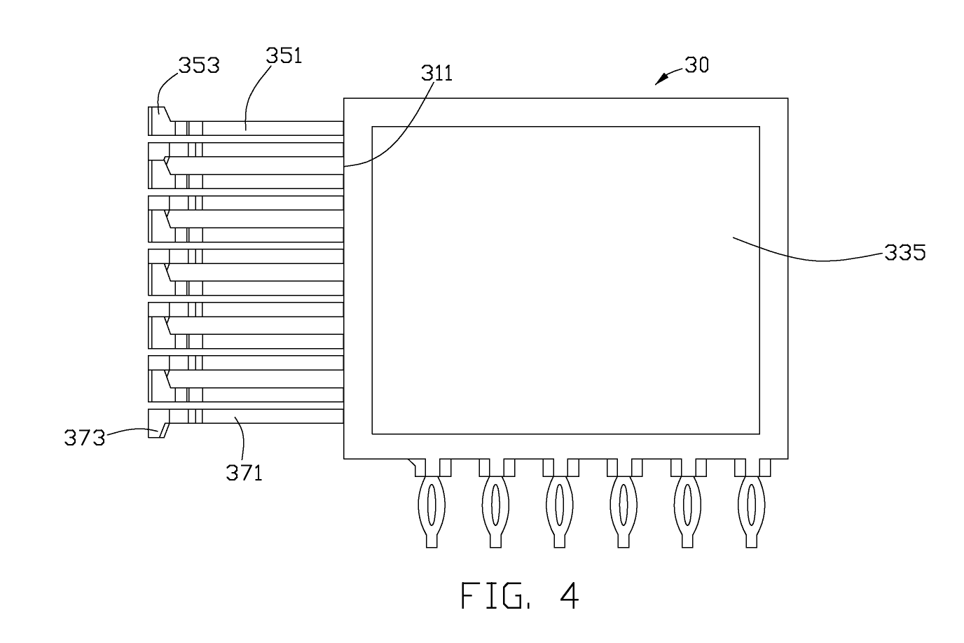

Referring to FIGS. 3-5, the first contacts 35 of each contact module 30 are stamped from a first metal sheet and the second contacts 37 of each contact module 30 are stamped from a second metal sheet which is separated from the first metal sheet. As a result of this arrangement, for each of the first and the second contacts 35, 37, a structure thereof is easy to manufacture from a single carrier strip. Besides, the first and the second contacting sections each is made from a single metal sheet in order to provide robust elasticity thereof and decrease the insertion force for smoothly mating with the contact of header connector. The first and the second contacts 35, 37 are separated from each other before both married and embedded in the insulator 31. However, the first and the second contacts 35, 37 come into contact with each other while they are embedded and married in the insulator 31 as shown in FIGS. 5-7. The stacked first and the second bodies 355, 375 and the first and the second tail ends 354, 374 are provided for controlling and ensuring impedance matching.

In assembly, the contact modules 30 are inserted to the shroud 10. The contacting sections 352, 372 are received in the same hole 101 as shown in FIG. 7. The enlarged distal ends 353, 373 abut against inner sides of the hole 101 for guiding the insertion of the contacts of the header connector.

It is to be understood, however, that even though numerous, characteristics and advantages of the present invention have been set forth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. An electrical connector comprising:
a shroud; and
a plurality of contact modules side-by-side assembled to the shroud, each contact module comprising an insulator with paired first and second contacts embedded and stacked against each other in the insulator; the first and the second contacts respectively comprising first and second contact arms extending along a first direction, the first and the second contact arms respectively comprising first and second contacting sections overlapping as viewed from a second direction perpendicular to the first direction; wherein
the first and the second contacts are separately made.

2. The electrical connector as claimed in claim 1, wherein the first direction is a horizontal direction and the second direction is a vertical direction.

3. The electrical connector as claimed in claim 1, wherein the first and the second contacts mechanically and electrically touch each other.

4. The electrical connector as claimed in claim 1, wherein the first and the second contact arms extend substantially parallel to each other and are located one above the other.

5. The electrical connector as claimed in claim 1, wherein the first and the second contacting sections are curvilinear and bent towards each other to overlap associated first and second contacting sections along the second direction.

6. The electrical connector as claimed in claim 1, wherein the shroud comprises a plurality of rear slots receiving the corresponding contact modules and a plurality of front holes and wherein the first and the second contacting sections of a contact pair are associated with a same front hole, the first and the second contacting sections respectively comprising enlarged first and second distal ends bent outwardly from the corresponding first and the second contacting sections for guiding insertion of a contact of a mating connector.

7. The electrical connector as claimed in claim 1, wherein the first contact comprises a first tail and a first body connecting the first contact arm and the first tail, and the second contact comprises a second tail and a second body connecting the second contact arm and the second tail, the first and the second bodies being embedded in the insulator.

8. The electrical connector as claimed in claim 7, wherein the first and the second bodies are aligned with each other along a third direction perpendicular to the first and the second directions, the first and the second bodies directly touching each other.

9. The electrical connector as claimed in claim 7, wherein the first and the second tails directly touch each other.

10. The electrical connector as claimed in claim 9, wherein the first and the second tails are for being compressibly received in a same hole of a circuit board.

11. A contact module comprising:
an insulator; and
first and second contacts each comprising a cantilevered contact arm extending along a rear-to-front direction, a tail end and a body connecting the contact arm and the tail end, the contact arms each comprising a curved contacting section bent towards each other to overlap the contacting sections along a vertical direction perpendicular to the rear-to-front direction, the bodies of the first and the second contacts being embedded in the insulator; wherein
the first and the second contacts touch each other and the tail ends of the first and the second contacts are for being received in a same hole of a circuit board.

12. The contact module as claimed in claim 11, wherein the contact arms of the first and the second contacts extend substantially parallel to each other and are located one above the other.

13. The contact module as claimed in claim 11, wherein the bodies of the first and the second contacts are aligned with each other along a third direction perpendicular to the rear-to-front direction and the vertical direction.

14. The contact module as claimed in claim 13, wherein the bodies of the first and the second contacts directly touch each other.

15. The contact module as claimed in claim 11, wherein the tail ends of the first and the second contacts directly touch each other.

16. The contact module as claimed in claim 15, wherein the tail ends of the first and the second contacts are for being compressibly received in the same hole of the circuit board.

17. An electrical connector assembly comprising:
an insulative housing defining at least one row of through holes in a front portion thereof, each hole extending in a front-to-back direction while said row extending along a vertical direction perpendicular to said front-to-back direction;
a single groove disposed in a rear portion of the housing and extending in both said vertical direction and said front-to-back direction to simultaneously communicate with all said through holes in said front-to-back direction;
a terminal module located behind the housing in said front-to-back direction and equipped with a plurality of contacts, each of said contacts defining opposite first and second parts essentially mostly stacked with each other in a transverse direction perpendicular to both said vertical direction and said front-to-back direction, said contacts defining contacting portions arranged parallel to one another in said vertical direction; wherein
in each contact, the first part defines a first resilient contacting section extending in said front-to-back direction at a lower level in the groove with a first front contacting apex section while the second part defines a second resilient contacting section extending in said front-to-back direction at a higher level in the groove with a second front contacting apex section; wherein
both said first front contacting apex section and said second front contacting apex section, which are adapted to cooperate with each other to sandwich a blade type complementary contact of a mating connector, are forwardly exposed to an exterior in said front-to-back direction through the corresponding through hole under condition that the first front contacting apex section and the second front contacting apex section are at least partially overlapped with each other in said vertical direction.

18. The electrical connector assembly as claimed in claim 17, wherein in each contact, a front end of the first resilient contacting section defines a downward tab extending downwardly in the vertical direction while the front end of the second resilient contacting section defines an upward tab extending upwardly in the vertical direction under condition that the downward tab is partially overlapped, in the transverse direction, with the upward tab of the adjacent contact below while the upward tab is partially overlapped, in the transverse direction, with the downward tab of the adjacent contact above.

19. The electrical connector assembly as claimed in claim 18, wherein the upward tab and the downward tab do not communicate, in the front-to-back direction, with the exterior via the corresponding through hole for exposure to the exterior but are hidden behind a front face of the housing.
